(19) United States
(12) Patent Application Publication
(10) Pub. No.: US 2025/0177984 A1
(43) Pub. Date: Jun. 5, 2025

(54) PLATFORM FOR INTRACELLULAR DELIVERY USING DROPLET MICROFLUIDICS

(71) Applicants: MXT BIOTECH, Seoul (KR); Korea University Research and Business Foundation, Seoul (KR)

(72) Inventors: Aram CHUNG, Seoul (KR); Byeong-Ju JOO, Seoul (KR); Ju-Hee LEE, Seoul (KR)

(73) Assignees: MXT BIOTECH, Seoul (KR); Korea University Research and Business Foundation, Seoul (KR)

(21) Appl. No.: 18/633,084

(22) Filed: Apr. 11, 2024

(30) Foreign Application Priority Data
Nov. 30, 2023 (KR) 10-2023-0170705
Jan. 23, 2024 (KR) 10-2024-0010157

(51) Int. Cl. B01L 3/00

(52) U.S. Cl. CPC B01L 3/502784; B01L 2200/06; B01L 2400/086

(57) ABSTRACT

This invention relates to a device for delivering substances within cells, comprising one or more main channels that extend in a first direction from one end to another and are equipped with a fluid passage inside; a first supply part connected to one end of the main channel, which injects a first fluid containing the cells and substances; and a second supply part connected to one end of the main channel, which injects a second fluid that does not mix with the first fluid. The interior of the main channel includes one or more compressing blocks, pertaining to a cell interior substance delivery platform.

### CROSS-REFERENCE TO RELATED APPLICATIONS

This application claims priority to and the benefit of Korean Patent Application Nos. 10-2023-0170705 filed on Nov. 30, 2023 and 10-2024-0010157 filed on Jan. 23, 2024, in the Korean Intellectual Property Office, the entire contents of which are incorporated herein by reference.

### TECHNICAL FIELD

This invention relates to a droplet microfluidics-based intracellular delivery platform. More specifically, it concerns a platform capable of delivering external materials into cells with high efficiency without damaging the cells.

### BACKGROUND

Intracellular delivery is one of the most fundamental experiments in cell engineering, typically involving the use of carriers or the creation of nanopores in the cell/nuclear membrane to deliver external cargos.

Virus or Lipofectamine-based Carrier technology or method can achieve highly efficient intracellular delivery when optimized, but have issues like safety concerns, time-consuming delivery process, labor and cost-intensive carrier preparation processes, and low reproducibility.

Conversely, methods that create nanopores in cell membranes by applying external forces (e.g., electroporation or microneedles) have the advantage that they are relatively independent on cell and cargo types. However, these methods are limited by low cell survival rates due to their invasive nature, denaturation of the delivered materials, and low throughput.

To address these issues, the use of microfluidic devices capable of processing a large number of cells has become prominent. A typical approach involves creating a bottleneck section in a microchannel, where cells undergo physical deformation as they pass through, creating nanopores in the cell membrane. However, this approach has significant drawbacks, such as blockage of the bottleneck section during experiments and inconsistent material delivery efficiency.

Therefore, various studies are being conducted to find methods to deliver materials to a variety of cells efficiently and without causing damage to the cells.

### SUMMARY OF THE INVENTION

This summary is provided to introduce a selection of concepts that are further described below in the Detailed Description. This summary is not intended to identify key or essential features of the claimed subject matter, nor is it to be used as an aid in limiting the scope of the claimed subject matter.

The objective of this invention is to provide a droplet-based intracellular delivery platform capable of delivering materials to various cells with high efficiency. Another objective of this invention is to reduce unnecessary loss of the materials being delivered and to provide an intracellular delivery platform capable of processing a large number of cells continuously. The technical objects of the present disclosure are not limited to the foregoing technical objects, and other non-mentioned technical objects will be clearly understood by those skilled in the art from the description below.

According to one aspect of the invention, the embodiments of the invention include an intracellular delivery platform.

In one embodiment, the device or platform for delivering intracellular material comprises one or more main channels, each extending in a first direction from one end to another and equipped with a fluid passage inside; a first supply unit connected to one end of the main channel for injecting a first fluid containing the cells and material; and a second supply unit connected to one end of the main channel for injecting a second fluid that does not mix with the first fluid. The main channel includes one or more compressing blocks inside for the intracellular delivery platform.

In one embodiment, the first fluid can be an aqueous phase, and the second fluid can be an oil phase.

In one embodiment, the first supply unit can extend parallel to the first direction and connect to one end of the main channel, while the second supply unit can be connected at an angle to the first supply unit at one end of the main channel.

In one embodiment, the first fluid from the first supply unit is delivered to one end of the main channel, and the second fluid from the second supply unit is delivered to one end of the main channel at an angle to the flow direction of the first fluid, forming the first fluid, including the cells and material, into droplets. These droplets can pass through the main channel within the second fluid.

In one embodiment, the second supply unit includes first and second supply channels, which connect to one end of the main channel to form a junction.

In one embodiment, the compressing block is provided at a part spaced apart by a first length from one end of the main channel, and the first length can be 30% to 90% of the total length from one end of the main channel to the other.

In one embodiment, the flow rate of the second fluid in the main channel can be 1 mL/h to 70 mL/h.

In one embodiment, the device may further include one or more sub-channels connected at an angle to the main channel, through which the second fluid flows.

In one embodiment, the sub-channel is connected to the main channel at a part spaced apart by a second length from one end of the main channel and includes first and second sub-channels, which can be connected to one side and the other side of the main channel, respectively.

In one embodiment, the inner width of the sub-channel is set to be 20% to 150% of the first width, which is the inner width of the main channel, and the second fluid can be delivered to the main channel through the sub-channel.

In one embodiment, the inner width of the sub-channel is 20 μm to 200 μm, and the first width, which is the inner width of the main channel, is 20 μm to 1.5 mm, and the second fluid can be delivered to the main channel through the sub-channel.

In one embodiment, the flow rate of the second fluid in the main channel is 1 mL/h to 45 mL/h, and in the sub-channel, the flow rate of the second fluid is 1 mL/h to 30 mL/h.

In one embodiment, the compressing block is provided at a part spaced apart by a first length from one end of the main channel, and this first length can be 1.1 to 5 times the second length.

In one embodiment, the first width is 20 μm to 1.5 mm, the first length is 0.1 mm to 30 mm, and the second length is 0.1 mm to 1.5 mm.

In one embodiment, the length of the compressing block in the direction parallel to the first direction can be 10 μm to 200 μm.

In one embodiment, the length of the compressing block in the direction parallel to the first direction can be 20 μm to 100 μm.

In one embodiment, the gap between the compressing block and the inner surface of the main channel is the second width, which can be 0.1% to 85% of the first width, the inner width of the main channel.

In one embodiment, the second width can be 2 μm to 17 μm.

In one embodiment, the height of the compressing block in the direction perpendicular to the first direction can be 15% to 99% of the first width.

In one embodiment, the height of the compressing block in the direction perpendicular to the first direction can be 3 μm to 1.5 mm.

In one embodiment, the main channel includes an inlet part connected to the first supply unit; a branch part connected to the inlet part but divided into multiple passages; and an outlet part connected to the branch part. The branch part includes multiple passages with smaller widths than the inlet and outlet parts and links where these passages branch or connect. The compressing block can be provided in the branch part or the outlet part.

In one embodiment, droplets formed from the cells, material, and first fluid are delivered from the inlet part through the branch part to the outlet part via the second fluid. Droplets in the inlet part can have a larger average diameter than those in the branch part or outlet part.

In one embodiment, the branch part can be symmetrically arranged around a virtual baseline connecting the inlet and outlet parts.

In one embodiment, the main channel may further include one or more curved passages provided in the inlet or branch part.

In one embodiment, the material can include one or more of nucleic acids, proteins, transcription factors, vectors, plasmids, gene-editing substances, and nanoparticles.

### Effect of the Invention

As examined above, according to this invention, a high-efficiency intracellular delivery platform can be provided, which delivers materials into various cells without damaging the cells.

Furthermore, according to this invention, materials can be delivered into cells without limitation to the type of material using a novel method, providing a mass-production-friendly intracellular delivery platform that can deliver various materials into one cell or one material into various cells.

The technical solutions obtainable from the present disclosure are not limited to the foregoing solutions, and other non-mentioned solution means will be clearly understood by those skilled in the art from the description below.

### BRIEF DESCRIPTION OF THE DRAWINGS

Various aspects are described with reference to the drawings, and herein, like reference numerals are generally used to designate like constituent elements. In the exemplary embodiment below, for the purpose of description, a plurality of specific and detailed matters is suggested in order to provide general understanding of one or more aspects. However, it is apparent that the aspect(s) may be carried out without the specific and detailed matters. In other examples, well-known structures and devices are illustrated in a block diagram in order to facilitate describing one or more aspects.

FIG. 1 is a schematic of the intracellular delivery platform according to an embodiment of the invention.

FIG. 2 shows an intracellular delivery platform according to an embodiment of the present invention.

FIG. 3 is a cross-sectional view of FIG. 2.

FIG. 4 shows an intracellular delivery platform according to another embodiment of the invention.

FIG. 5 is a cross-sectional view of FIG. 4.

FIG. 6 shows an intracellular delivery platform according to yet another embodiment of the invention.

FIG. 7 shows an intracellular delivery platform according to another embodiment of the present invention.

FIG. 8 is an enlarged view of the main channel in FIG. 7.

FIG. 9 shows a diagram of the branch part in FIG. 7.

FIG. 10 shows an intracellular delivery platform according to another embodiment of the invention.

FIG. 11 is a diagram confirming intracellular delivery using the intracellular delivery platform according to the present embodiment.

FIG. 12 shows the results of confirming the efficiency of intracellular delivery depending on the size of the compressing block in the intracellular delivery platform according to FIG. 11.

FIG. 13 shows the results of confirming the efficiency of intracellular delivery depending on the type of delivery material in the intracellular delivery platform according to FIG. 11.

FIG. 14 shows a table of the status of the adoption of conventional universal devices for intracellular gene delivery.

FIG. 15 compares the editing efficiency of the EMX1 target gene with conventional universal methods.

FIG. 16 shows the results of confirming intracellular delivery using a droplet separation type intracellular delivery platform.

This text details various aspects of an intracellular delivery platform, illustrating different embodiments, efficiencies, and comparisons with conventional methods.

### DETAILED DESCRIPTION

Specific details of other embodiments are included in the detailed description and drawings.

The advantages and features of the present invention, and the ways to achieve them, will become clear by referring to the embodiments described in detail along with the accompanying drawings. However, the present invention is not limited to the embodiments disclosed below and can be implemented in various different forms. Unless otherwise specified in the following description, all numbers, values, and/or expressions representing components, reaction conditions, and component contents in the present invention are approximate values reflecting the various uncertainties that arise in obtaining these values among inherently different ones and should be understood to be qualified by the term “about” in all cases. Moreover, when a numerical range is disclosed herein, such ranges are continuous and include all values from the minimum to the maximum value of the range, unless otherwise indicated. Furthermore, if such a range refers to integers, it includes all integers from the minimum to the maximum value, unless otherwise indicated.

Also, when a range is stated for a variable in the present invention, it is to be understood that the variable includes all values within the stated range, including the endpoints of the range. For example, the range “5 to 10” includes not only the values 5, 6, 7, 8, 9, and 10 but also any subranges such as 6 to 10, 7 to 10, 6 to 9, 7 to 9, etc., and also any value between valid integers within the stated range, such as 5.5, 6.5, 7.5, 5.5 to 8.5, and 6.5 to 9, etc. For example, the range “10% to 30%” includes all integers up to 30% as well as values like 10%, 11%, 12%, 13%, etc., and any subrange such as 10% to 15%, 12% to 18%, 20% to 30%, etc., and also any value between valid integers within the stated range, such as 10.5%, 15.5%, 25.5%, etc.

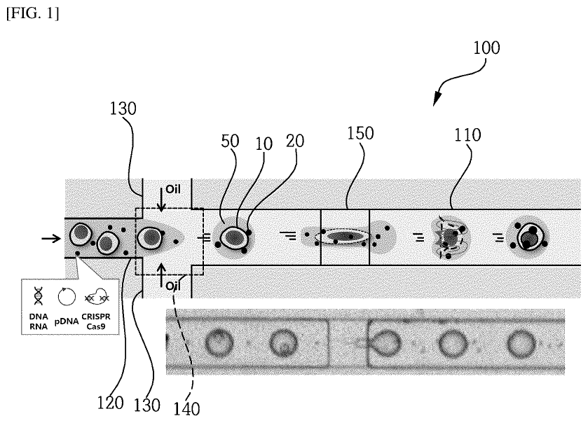

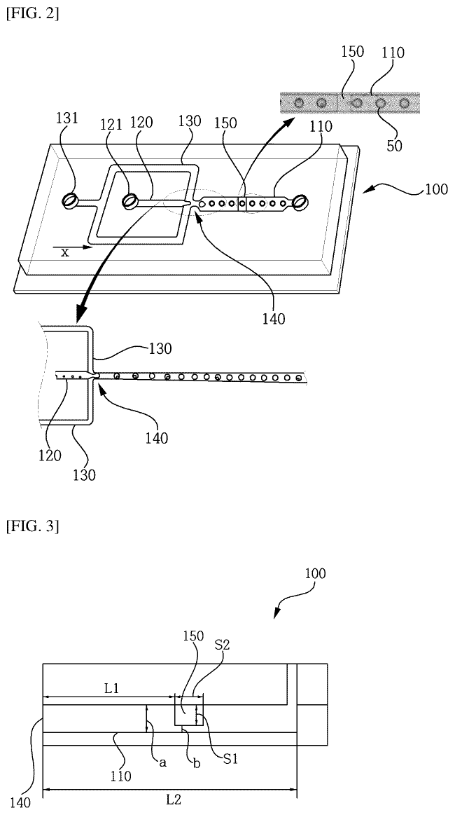

FIG. 1 is a schematic diagram of an intracellular delivery platform according to an embodiment of the present invention. FIG. 2 shows an intracellular delivery platform according to an embodiment of the invention. FIG. 3 is a cross-sectional view of FIG. 2.

An embodiment of the present invention relates to an intracellular delivery platform (100) for delivering materials into cells, extending in a first direction (x) from one end to the other, comprising one or more main channels (110) equipped with a fluid passage; a first supply part (120) connected to one end of the main channel (110) for injecting cells (10), material (20), and a first fluid; and a second supply part (130) connected to one end of the main channel (110) for injecting a second fluid that does not mix with the first fluid.

Inside the main channel (110) is provided one or more compressing blocks (150), where the first fluid can be an aqueous phase and the second fluid an oil phase.

The intracellular delivery platform (100) according to this embodiment uses unmixed first and second fluids to form droplets, capable of capturing cells (10) and the material (20) intended for delivery into the cells within these droplets (50). The droplets (50) are formed of the same material as the first fluid and can move the cells (10) and material (20) while maintaining their droplet (50) form within the second fluid.

Conventional methods of delivering materials into cells, such as electroporation, often damage the cell membrane, leaving permanent traces on the cells. Also, methods that involve directly applying external force to cells while they flow with the material in a fluid can cause cell damage or result in low efficiency of material delivery into the cells.

In contrast, the intracellular delivery platform (100) according to this embodiment uses droplets (50) to effectively deliver material (20) into cells (10) while preventing cell damage. In this platform, cells (10) and material (20) are protected by the droplets (50) and can flow efficiently within the fluid. Additionally, the close proximity of cells (10) and material (20) inside the droplets (50) prevents the loss of material (20) and allows for its efficient delivery into the cells.

The intracellular delivery platform (100) according to this embodiment may further include compressing blocks (150). Located inside the main channel (110), these compressing blocks (150) can reduce the effective width of the main channel (110). Specifically, as the droplets (50) pass through the main channel (110) at a certain speed driven by the second fluid, they are compressed when passing through the compressing blocks (150). During this process, deformation of the cells (10) occurs, creating nanopores in the cell or nuclear membrane, through which the material (20) can effectively be delivered into the cells. After passing through the compressing block (150), the droplets (50) regain their shape, creating a vortex inside, which provides propulsion for the material (20) to be delivered into the cells, thereby enhancing the efficiency of intracellular delivery. The deformed cells (10) then recover their original shape and contain the material (20).

The droplets (50) can be provided with a very small volume, approximately −100 pL/cell. In the main channel (110), the amount of material (20) to be delivered is determined by the volume of the droplets (50). Typically, in cellular material delivery systems, the distance between the cells and the material to be delivered reduces the efficiency of intracellular delivery, or a large amount of material is used to increase the concentration around the cells, making the process inefficient. However, the intracellular delivery platform (100) according to this embodiment allows for efficient delivery of material (20) into cells (10) with a minimal amount of material (20), reducing unnecessary loss.

In the intracellular delivery platform (100) according to this embodiment, the volume of the droplets (50) is minimal, and the cells (10) can be provided in an environment of high concentration of material (20) within the droplets (50). When the droplets (50) pass through the compressing blocks (150), causing deformation of the cells (10) and the formation of nanopores, even a very small volume of droplets (50) can effectively deliver material (20) into the cells. Additionally, the shape of the droplets (50) is maintained after passing through the compressing block (150), and secondary flows such as vortices within the droplets (50) can provide propulsion for more effective delivery of the material (20) into the cells.

The intracellular delivery platform (100) can be applied to macromolecules such as larger nanoparticles and plasmid DNA, which was not possible with conventional technology. It prevents problems such as blockages and low cell survival rates due to high flow rates that occur when cells are passed through microtubes or narrow passages (bottlenecks) in conventional methods.

In the intracellular delivery platform (100) according to this embodiment, the inner walls of the main channel (110) can be hydrophobic. The second fluid that flows the droplets (50) in the main channel (110) is hydrophobic, allowing it to flow easily inside the main channel (110). The droplets (50) are hydrophilic, minimizing blockage due to the difference in hydrophilicity and hydrophobicity with the main channel (110).

The intracellular delivery platform (100) does not suffer from blockage, allowing for high-efficiency intracellular delivery, and can also exhibit a high cell survival rate by moving the cells at an appropriate flow rate.

The first supply part (120) extends parallel to the first direction (x) and is connected to one end of the main channel (110), and the second supply part (130) can be connected at an angle to the first supply part (120) at one end of the main channel (110). For example, the first supply part (120) and the main channel (110) can be connected horizontally, and the second supply part (130) can be connected at a certain angle to the main channel (110). More specifically, the second supply part (130) can be connected perpendicularly to the main channel (110).

One end of the first supply part (120) is connected to one end of the main channel (110), and the other end of the first supply part (120) can be connected to the first supply chamber (121). The first supply chamber (121) is equipped with the first fluid, cells (10), and material (20), which can be delivered to the first supply part (120).

One end of the second supply part (130) is connected to one end of the main channel (110), and the other end of the second supply part (130) can be connected to the second supply chamber (131). The second supply chamber (131) is equipped with the second fluid, which can be delivered to the second supply part (130) at a certain flow rate.

In the first supply part (120), the first fluid, cells (10), and material (20) are delivered to one end of the main chamber (110), and in the second supply part (130), the second fluid is delivered to one end of the main chamber (110) at an angle to the flow direction of the first fluid, forming droplets (50) containing the cells (10) and material (20). These droplets (50) flow from one end to the other end of the main channel (110) along with the second fluid, passing through the compressing block (150) of the main channel (110).

The flow rate of the first fluid from the first supply part (120) or the second fluid from the second supply part (120) can be controlled to regulate the size and movement speed of the droplets (50). The intracellular delivery platform (100) according to this embodiment can enhance the efficiency of material delivery into cells (10) by controlling the size and speed of the droplets (50) according to the size of different cells (10) or types of material (20) to be delivered.

Specifically, the second supply part (130) may include first and second supply channels. These channels can be a pair of microchannels, each located on one side of the first supply part (120). They can connect to one end of the main channel (110) to form a cross, Y-shaped, or T-shaped junction (140).

Specifically, the first supply part (120) can extend to connect with the main channel (110). The first supply channel can connect vertically from above and the second supply channel vertically from below at the connection point between the first supply part (120) and the main channel (110). The first fluid delivered through the first supply part (120) forms droplets (50) at the junction (140) with the second fluid delivered from the first and second supply channels, and these droplets can flow through the main channel (110) with the second fluid.

Compressing blocks (150) can be equipped on the inner surface of the main channel (110). These blocks can reduce the passage in the main channel (110) and can be positioned on the upper, lower, or side surfaces. The surfaces of the compressing blocks (150) can be hydrophobic to prevent obstruction of the flow of the second fluid.

The compressing blocks (150) can be approximately box-shaped with a height (S1) protruding from the upper inner surface of the main channel (110) and a length (S2) parallel to the first direction (x). The blocks may have rounded edges to prevent the formation of vortices at their corners.

The second fluid and droplets (50) can pass through the compressing block (150) inside the main channel (110). As they pass through, the droplets (50) are deformed due to the reduced flow path and increased flow rate caused by the compressing block (150), leading to the deformation of the cells (10) and formation of nanopores in the cell membrane. The material (20) can be delivered into the cells through these nanopores. The droplets (50) can regain their shape after passing through the compressing block (150), and the cells (10) inside the droplets can also return to their original shape. Secondary vortices can form inside the droplets (50) during this shape recovery process, promoting the movement of the material (20) and facilitating its delivery into the cells.

The inner width of the main channel (110) is the first width (a), and the gap between the compressing block (150) and the inner surface of the main channel (110) is the second width (b), which can be set from 0.1% to 85% of the first width (a). If the second width (b) is less than 0.1% of the first width (a), it can damage the cells (10) passing between the main channel (110) and compressing block (150), and if it exceeds 85%, it may not sufficiently pressurize the droplets (50) affecting the efficiency of intracellular delivery.

The second width (b) can range from 2 μm to 17 μm. This range allows the droplets (50) to be pressurized without damaging the cells (10), inducing physical deformation of the cells and improving the efficiency of intracellular delivery.

The length (S2) of the compressing block (150) parallel to the first direction (x) can be between 10 μm and 200 μm. If the length (S2) is less than 10 μm, effective intracellular delivery may not occur, and if it exceeds 200 μm, the increased contact area with the compressing block (150) can damage the cells (10). Specifically, the length (S2) can be between 20 μm and 100 μm.

The height (S1) of the compressing block (150) perpendicular to the first direction (x) can be between 15% and 99% of the first width (a). Specifically, the height (S1) can range from 3 μm to 1.5 mm. This range prevents blockage by the compressing block (150) and allows for effective intracellular delivery.

The compressing block (150) can be positioned at a distance of the first length (L1) from one end of the main channel (110). Specifically, for the total length (L2) from one end to the other end of the main channel (110), the first length (L1) can be 30% to 90% of the total length (L2). If the first length (L1) is less than 30% of the total length (L2), the flow of the droplets and the second fluid before passing the compressing block (150) may not be stable, and if it exceeds 90%, the deformed droplets and cells may not have enough time to recover after passing through the compressing block (150).

Flow controllers can be equipped in the main channel (110), and first and second supply parts (120, 130), controlling the speed and Reynolds number of the first and second fluids passing through. Specifically, the flow rate of the second fluid in the main channel (110) can be 1 mL/h to 70 mL/h. If the flow rate is less than 1 mL/h, the droplets (50) may clump together, and if it exceeds 70 mL/h, the droplets may not form smoothly at the junction (140).

The material can include one or more of nucleic acids, proteins, transcription factors, vectors, plasmids, gene editing materials, and nanoparticles.

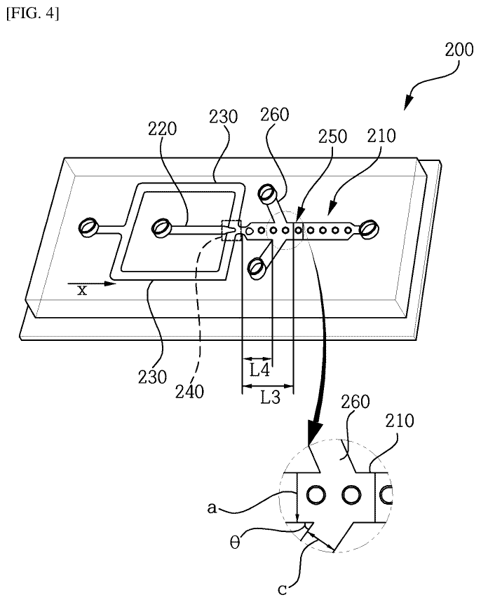

The following describes other embodiments of the present invention with reference to FIGS. 4 to 10. Except for the contents to be described later, it is similar to the embodiments described in FIGS. 1 to 3, so detailed description thereof is omitted.

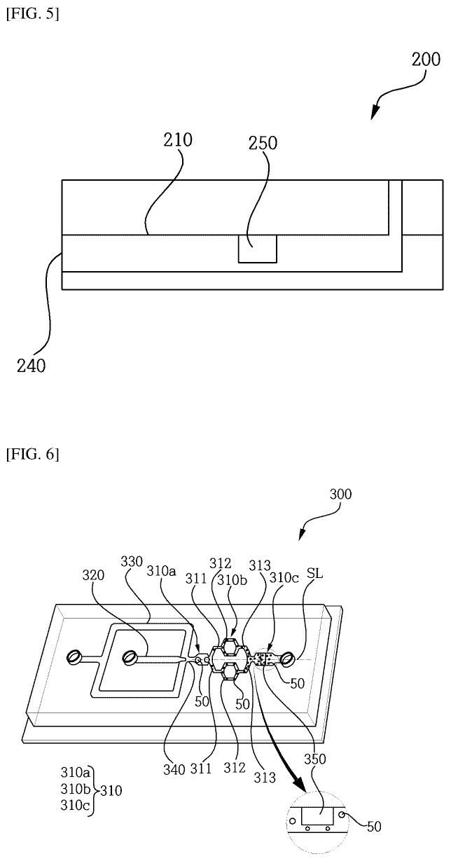

FIG. 4 shows a diagram of an intracellular delivery platform according to another embodiment of the invention. FIG. 5 is a cross-sectional view of FIG. 4.

Referring to FIGS. 4 to 5, the intracellular delivery platform (200) according to this embodiment can include a main channel (210) containing one or more droplets comprising cells and material and a first fluid, and a second fluid that moves these droplets; a first supply part (220) connected to one end of the main channel (210) for delivering the first fluid, cells, and material; and a second supply part (230) connected at an angle to one end of the main channel (210) for delivering the second fluid. At the junction (240) where the main channel (210), first, and second supply parts (220, 230) meet, droplets are formed and can be transferred from one end of the main channel (210) to the other.

The main channel (210) can be equipped with compressing blocks (250) that pressurize the droplets passing through the main channel (210). The compressing blocks (250) can induce primary intracellular delivery due to the instantaneous cellular deformation caused by the pressurization of the droplets, and secondary intracellular delivery can be induced by vortices occurring inside the droplets after passing through the compressing blocks (250).

The intracellular delivery platform (200) may further include one or more sub-channels (260) through which the second fluid flows. The sub-channel (260) can be connected at an angle (θ) at a distance of the second length (L4) from one end of the main channel (210). The sub-channel (260) can be connected to the main channel (210) at an angle of approximately 30° to 75° to prevent turbulence in the main channel (210), ensuring smooth flow of the droplets.

The sub-channel (260) can deliver the second fluid to the main channel (210) after the formation of the droplets, and a flow controller can be equipped in the sub-channel (260) to control the flow rate of the second fluid passing through it.

The sub-channel (260) can deliver the same second fluid outwardly to the flow of the second fluid in the main channel (210), preventing friction between the droplets and the inner walls of the main channel (210) and allowing the droplets to pass through the main channel (210).

The subchannels (260) may include a pair of first and second subchannels. These first and second subchannels can be respectively located on one side and the other side of the main channel (210). Specifically, the first and second subchannels can be connected to the main channel (210) at an angle, positioned at a distance corresponding to the second length (L4) from one end of the main channel (210). The first and second subchannels (260) can be provided in pairs and located at approximately the same position along the main channel (210).

The inner width (c) of the subchannels (260) can be configured to be 20% to 150% of the first width (a), which is the inner width of the main channel (210). By setting the inner width (c) of the subchannels (260) within this range, the flow of the second fluid within the main channel (210) can be facilitated without creating unnecessary turbulence, thus easily moving the droplets. For example, the inner width (c) of the subchannels (260) can be between 20 μm and 200 μm, while the first width (a) of the main channel can be between 20 μm and 1.5 mm.

The flow rate of the second fluid delivered from the subchannels (260) to the main channel (210) can be the same as or different from the flow rate of the second fluid in the main channel (210). Specifically, the flow rate of the second fluid in the main channel (210) can be between 1 mL/h and 45 mL/h, and the flow rate of the second fluid in the subchannels (260) can be between 1 mL/h and 30 mL/h.

The compressing block (250) is positioned a certain first length (L3) away from one end of the main channel (210), and this first length (L3) can be 1.1 to 5 times the second length (L4), which is the distance from one end of the main channel (210) to where the subchannels (260) are located. By controlling the first length (L3) and the second length (L4) within the aforementioned range, the efficiency of intracellular delivery by the compressing block (250) can be improved, and it can efficiently process a large number of cells.

Specifically, the first width (a) can be between 20 μm and 1.5 mm, the first length (L3) can be between 0.1 mm and 30 mm, and the second length (L4) can be between 0.1 mm and 1.5 mm.

FIG. 6 represents another embodiment of the intracellular delivery platform according to the invention.

Referring to FIG. 6, the intracellular delivery platform (300) according to this embodiment includes a main channel (310) through which the droplets (50) move to deliver material into the cells, a first supply part (320) that delivers droplets (50) composed of cells, material, and the first fluid to the main channel (310), and a second supply part (330) that delivers the second fluid to the main channel (310).

The main channel (310) may include an inlet section (310a) connected to the first supply part (320), a branching section (310b) connected to the inlet section (310a) but divided into multiple passages, and an outlet section (310c) connected to the branching section (310b). The branching section (310b) can have multiple passages (311, 312, 313) with smaller widths than the inlet (310a) and outlet sections (310c) and links where these passages (311, 312, 313) branch or connect. The compressing block (350) can be located in the branching section (310b) or the outlet section (310c).

Inside the main channel (310), droplets (50) formed of cells, material, and the first fluid, along with the second fluid, can be transferred from the inlet section (310a) through the branching section (310b) to the outlet section (310c). The droplets (50) located in the inlet section (310a) may have a larger average diameter than those in the branching (310b) or outlet sections (310c).

The branching section (310b) can be symmetrically arranged around a virtual baseline (SL) that horizontally connects the inlet section (310a) and the outlet section (310c). Specifically, the branching section (310b) includes multiple passages (311, 312, 313) with smaller widths than the inlet (310a) and outlet sections (310c), and links where these passages branch or connect. The compressing block (350) can be located in the branching section (310b) or the outlet section (310c). The branching section (310b) on either side of the virtual baseline (SL) can have corresponding connected passages (311, 312, 313) and branches, with droplets (50) entering through the inlet section (310a) and dividing to pass through the branching section (310b) on either side.

The branching section (310b) is connected from the inlet section (310a) and can form two primary passages (311) on each side of the branching section (310b). Each primary passage (311) can further split into two secondary passages (312) through links. These secondary passages (312) can extend individually and then reconnect through links to form a tertiary passage (313). The tertiary passage (313) on one side of the branching section (310b) and the tertiary passage (313) on the other side can connect to the outlet section (310c).

As the droplets (50) pass through the branching section (310b), their average diameter can decrease as the average width of the branching section (310b) is smaller than that of the inlet section (310a). The average diameter of the droplets (50) can be approximately similar to or less than 20% of the average width of the branching section (310b). As the droplets (50) pass through the branching section (310b), they can flow in a single file, thereby preventing cell damage and effectively controlling the delivery of material inside the cells.

In addition, one or more compressing blocks (350) can be provided at either the branching section (310b) or the outlet section (310c). As the droplets (50) pass through the compressing block (350), they are compressed, temporarily deforming the cell shape and creating nanopores in the cell or nuclear membrane. The shape of the droplets (50) is also deformed, reducing the distance between the material and the cells. The flow transformation of the first fluid inside the droplets (50) allows the material to be effectively delivered into the cells through these nanopores.

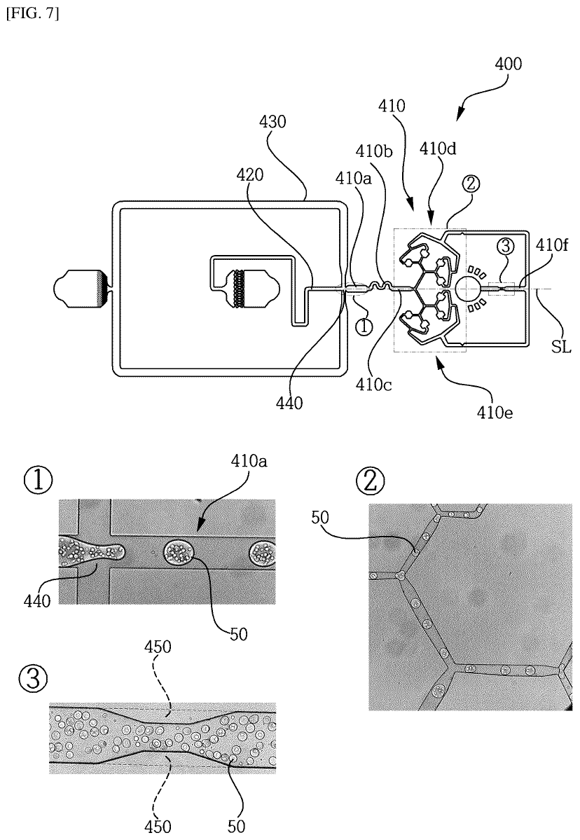

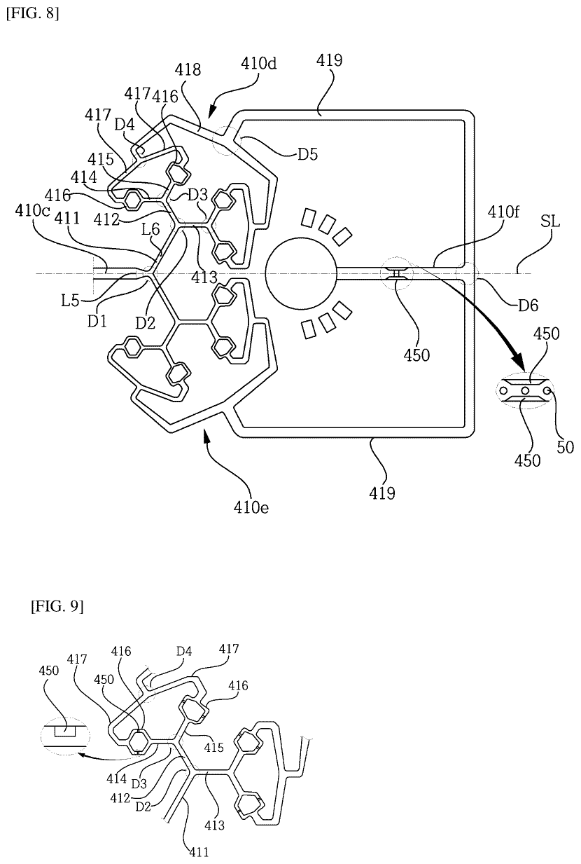

FIG. 7 is a drawing of another embodiment of the intracellular delivery platform according to the invention. FIG. 8 is an enlarged view of the main channel in FIG. 7, and FIG. 9 is a drawing of the branching section in FIG. 7.

Referring to FIGS. 7 to 9, the intracellular delivery platform (400) according to this embodiment may include a first supply part (420) where the first fluid containing cells and material is supplied, a main channel (410) connected to the first supply part (420), and a second supply part (430) supplying the second fluid to the part where the first supply part (420) and the main channel (410) are connected. At the junction (440), formed in a cross, Y, or T shape, where the first supply part (420), the second supply part (430), and the main channel (410) are connected, the first fluid containing cells and material can be formed into droplets (50) by the second fluid. These droplets can move within the main channel (410) along with the second fluid.

The main channel (410) may include sequentially connected inlet sections (410a, 410b, 410c), branching sections (410d, 410e), and an outlet section (410f). The main channel (410) may further include one or more curved passages (410b) provided in either the inlet sections (410a, 410b, 410c) or the branching sections (410d, 410e). Specifically, in this embodiment, the curved passage (410b) can be included in the inlet sections (410a, 410b, 410c) and can be provided in one or more curved shapes to control the flow speed of the second fluid and the droplets (50) in the main channel (410), and to generate vortex flow inside the droplets. This vortex flow can enhance the efficiency of material transfer within the droplets and mix the cells contained within them.

When cells within the droplets are uniformly mixed due to the flow generated by the curved passage (410b), the number of cells within the droplets can be evenly divided at the branching points where the flow of the second fluid divides. For example, if the droplets split into two at a branching point, the cells within the droplets can also be approximately divided in a 50:50 ratio, enabling control for uniform effects per batch.

The intracellular delivery platform (400) may include sections where droplets (50) are formed (\textcircled{1}), where the flow of the second fluid containing droplets is branched (\textcircled{2}), and where the droplets are compressed by the compressing block (450) to mechanically perforate the cells through mechanoporation (\textcircled{2}). The platform (400) can use immiscible first and second fluids to form droplets (50) consisting of cells, material, and the first fluid, and can move these droplets (50) with the second fluid. The average diameter, movement speed, and movement pattern of the droplets (50) can be controlled by the average width and the number of passages of the main channel (410). Additionally, the platform (400) can include a compressing block (450) to create reversible nanopores in the cells or the droplets (50) without damaging them, through mechanoporation. When the nanopores open, the material can be delivered into the cells and then the nanopores can close immediately to prevent the release of the material outside the cells, thus delivering the material into the cells without causing damage.

Specifically, the parts of the intracellular delivery system in FIG. 7 where droplets (50) are formed (\textcircled{1}), where the flow of the second fluid containing droplets is branched (\textcircled{2}), and where the droplets are compressed by the compressing block (450) to mechanically perforate the cells through mechanoporation (\textcircled{3}) are based on experimental results obtained by conducting experiments using the methods described. Specifically, for the cells, material, and the first fluid, 40 million/mL Jurkat cells (ATCC, TIB-152) were included, with the culture medium being Opti-mem from ThermoFisher. As the second fluid, fluorocarbon oil was used. The droplets formed from cells, material, and the first fluid decrease in size to form smaller droplets (50) as they pass through the branching section (410d, 410e). These smaller droplets (50) can capture a relatively small number of cells. Such droplets (50) can be compressed by the compressing block (450) to mechanically perforate the cells through mechanoporation at section (\textcircled{3}), enabling the delivery of material into the cells from within the droplets.

The inlet sections (410a, 410b, 410c) can include the first part (410a) where droplets (50) enter, connected to the junction (440), and the second part (410c) connected to the branching sections (410d, 410e), with a curved passage (410b) connecting the first part (410a) and the second part (410c).

The branching sections (410d, 410e) can be symmetrically arranged around a virtual baseline (SL) connecting the inlet sections (410a, 410b, 410c) and the outlet section (410f) vertically. Specifically, the branching sections on each side of the virtual baseline (SL) can be connected to a pair of primary passages (411) through a primary link (D1) from the second part (410c). For example, with the primary link (D1) in between, the second part (410c) and the pair of primary passages (411) can be connected at an angle to form T- or Y-shaped passages.

The average width (L6) of the primary passages (411) can be smaller than the average width (L5) of the terminal parts of the inlet sections (410a, 410b, 410c), specifically, 40% to 80% of the average width (L5).

The primary passages (411) can further connect to a pair of secondary passages (412, 413) through a secondary link (D2), and these can be connected to tertiary passages (414, 415) via tertiary links (D3). The tertiary passages (414, 415) can be branched into pairs and connected to a quaternary passage (416) with a circular or polygonal shape, leading to a fifth passage (417) that reconnects into a single passage. This fifth passage (417) can be connected through a fourth link (D4) to a sixth passage (418) and then to a seventh passage (419) via a fifth link (D5).

Each of the seventh passages (419) connected from either side of the branching sections (410d, 410e) can be connected to the outlet section (410f) via a sixth link (D6). The outlet section (410f), aligned parallel to the inlet sections (410a, 410b, 410c), can include one or more compressing blocks (450).

One or more compressing blocks (450) can be included in either the branching sections (410d, 410e) or the outlet section (410f). These compressing blocks (450) can physically compress the droplets (50), facilitating material delivery into the cells through mechanoporation. The compressing blocks (450) can be provided in the branching sections (410d, 410e), specifically at the fourth passages (416).

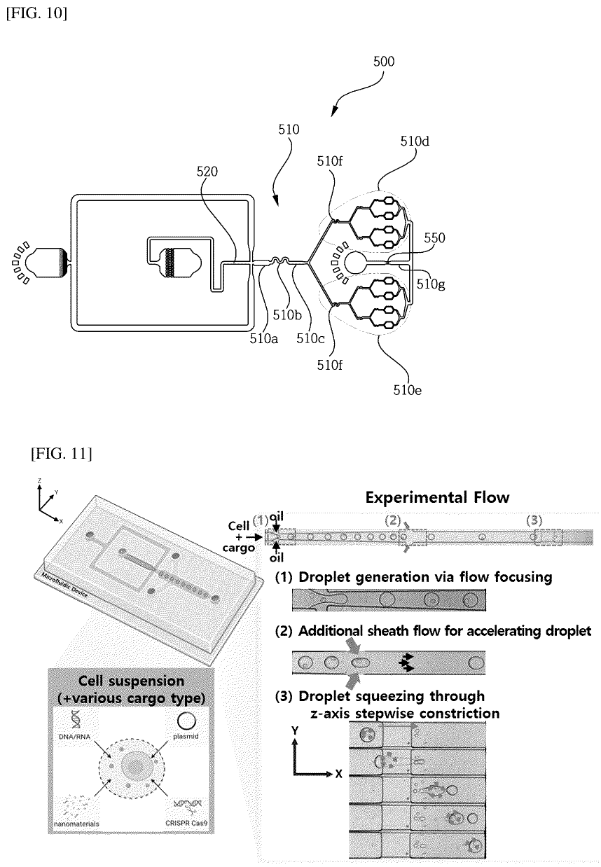

FIG. 10 is a drawing of another embodiment of the intracellular delivery platform according to the invention.

Referring to FIG. 10, the intracellular delivery platform (500) according to this embodiment may include a first supply part (520) supplying cells, material, and the first fluid, and a main channel (510) connected to the end of the first supply part (520), through which the droplets (50) move while delivering material into the cells.

The main channel (510) may include inlet sections (510a, 510b, 510c) connected to the first supply part (520), branching sections (510d, 510e, 510f) connected to the inlet sections and consisting of multiple passages, and an outlet section (510g) connected to the end of the branching sections and containing one or more compressing blocks (550).

The branching sections (510d, 510e, 510f) may be symmetrically arranged around a central part, consisting of multiple passages and links connecting these passages, and may be smaller in size than the average width of the inlet sections (510a, 510b, 510c) or the outlet section (510g).

The inlet sections (510a, 510b, 510c) or the branching sections (510d, 510e, 510f) are designed to provide passages for the droplets and the second fluid, with at least some linear and some curved passages (510b, 510f) included. The curved passages (510b, 510f) can generate vortex flow within the droplets, enhancing material transfer efficiency and mixing cells within the droplets. The cells within the droplets can be uniformly mixed as they pass through these curved passages (510b, 510f), ensuring an even distribution of cells within the droplets. The droplets (50) can move in an aligned manner through these curved passages (510b, 510f), which may be provided in the inlet sections (510a, 510b, 510c) corresponding to the average width of the first curved passage (510b) and in the branching sections (510d, 510e, 510f) corresponding to the average width of the second curved passage (510f).

The inlet sections (510a, 510b, 510c) may include a first part (510a) connected to the first supply part (520) and a second part (510c) connected to the branching sections (510d, 510e, 510f), with a first curved passage (510b) provided between the first part (510a) and the second part (510c). The first curved passage (510b) can ensure uniform distribution of cells within the droplets formed in the first part (510a). The branching sections (510d, 510e, 510f) can include a patterned form of passages on one side (510d) and the other side (510e) of a pair of branching sections. Also, the branching sections (510d, 510e, 510f) can include a second curved passage (510f) connected to either side of the branching sections (510d, 510e) in a curved form. The sides (510d, 510e) of the branching sections can have identical or different patterned passage forms. The second part (510c) can connect to two passages that branch into the sides (510d) and (510e) of the branching sections, each containing one or more second curved passages (510f). The sides (510d) and (510e) of the branching sections can be symmetrically arranged around a central part.

The second curved passages (510f) can be provided at the start of the branching sections (510d, 510e) on each side, aligning the droplets (50) and the second fluid flowing into the branching sections in a single file, and evenly distributing the cells within the droplets (50).

Below are the embodiments and comparative examples of the invention. However, the embodiments listed are merely preferred embodiments of the invention, and the scope of the invention is not limited to these examples.

FIGS. 11 to 16 present results of experiments using the intracellular delivery platform according to the embodiments, comparing its efficiency with conventional techniques.

FIG. 11 shows a diagram verifying intracellular delivery using the platform according to the embodiment.

Referring to FIG. 11, the intracellular delivery platform was fabricated using PDMS (Polydimethylsiloxane) (Dow, Sylgard 184) and slide glass (Marienfeld Superior, HSU-1000612). A master mold with microfluidic patterns was created using photolithography and DRIE (Deep Reactive Ion Etching) processes on a silicon wafer, and the microfluidic patterns were replicated onto the PDMS surface using soft lithography. The patterned PDMS and slide glass were bonded using oxygen plasma bonding with a plasma cleaner (Femto science, CUTE). To ensure stable droplet formation, the internal microchannels of the platform were made hydrophobic using Surface coating oil 10 μL (RAN Biotechnologies, 909 FluoroCoat), followed by bonding and drying O/N at 75° C. in a forced convection oven (Jeio Tech, OF4-S).

The intracellular delivery platform thus fabricated had a total length of the main channel where droplets move and are formed at 3.1538 mm, an average inner width of the main channel at 80 μm, and compressing blocks positioned 2.0538 mm away from one end of the main channel. The height of the compressing blocks was 4.8 μm, and the length was 100 μm. Additionally, the subchannels with an average inner width of 49 μm were connected at about 58 degrees angle to the end of the main channel, 1 mm apart.

Cell suspension (ATCC, CCL-243) and fluorocarbon oil (Bio Rad, Droplet Generation Oil) were used as materials for the experiment of intracellular delivery using the mentioned platform. The cell suspension used contained 15 million K562 cells per mL. After preparing the cells, the cell suspension was made with culture medium (Corning, RPMI) and impurities in the oil were removed using a 0.2 μm syringe filter (Advantec, 13HP020AN/25HP020AN). Fluorocarbon oil and cell suspension were injected into disposable syringes (BD, Luer-lok Tip Syringe) and connected to the microfluidic platform with Capillary tubing (IDEX, 1/32″ OD PEEK Tubing). A syringe pump (Harvard Apparatus, 11 Elite Microfluidic Syringe Pump) was used to inject cell suspension and fluorocarbon oil into the intracellular delivery platform at a constant flow rate of 0.5 mL/h and 2.0 mL/h, respectively. The separately injected cell suspension and fluorocarbon oil met at the Flow focusing junction to form droplets, capturing cells within them. These droplets passed through the main channel while maintaining their droplet state with fluorocarbon oil. Fluorocarbon oil was additionally supplied at a rate of 16 mL/h through the subchannel connected to the main channel, accelerating the flow of droplets within the main channel. The droplets were surrounded by fluorocarbon oil in the main channel, facilitating their movement.

The droplets then passed through the compressing blocks within the main channel, inducing deformation of the cells within the droplets to form nanopores in the cell membrane. It was observed that the material coexisting in the droplets was transferred into the cells through these nanopores.

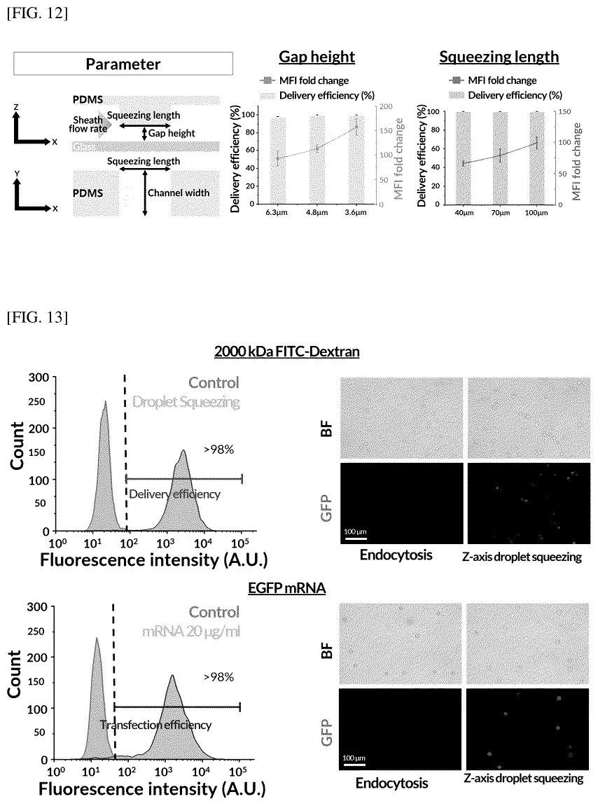

FIG. 12 shows results confirming the efficiency of intracellular delivery depending on the size of the compressing block in the intracellular delivery platform according to FIG. 11.

FIG. 12 used the same type of intracellular delivery platform as in FIG. 11, but varied the compressing blocks to confirm intracellular delivery efficiency. In these experiments, 2,000 kDa FITC-conjugated dextran (Sigma Aldrich, FD2000S) was diluted to a concentration of 0.3 mg/mL in the cell suspension and the experiments were conducted in triplicate for each condition. Cells treated through the intracellular delivery platform were cultured for 18 hours, and their delivery efficiency and mean fluorescence intensity fold change compared to the control group were analyzed using a flow cytometer (Merck, Guava EasyCyte).

In the intracellular delivery platform of FIG. 12, different gap heights (6.3 μm, 4.8 m, and 3.6 μm) between the main channel's inner surface and the compressing block were tested. It was found that the intracellular delivery efficiency increased in the order of 6.3 μm, 4.8 μm, and 3.6 μm, with the highest efficiency at 3.6 μm. Also, the efficiency of material delivery varied with the length of the compressing block (40 μm, 70 μm, and 100 μm), and 100 m showed the best results. The efficiency of intracellular delivery depending on the compressing block is presented in Tables 1 and 2.

TABLE 1

| Gap height | 6.3 μm | 4.8 μm | 3.6 μm |
|---|---|---|---|
| Delivery | 98.09% | 99.82% | 99.95% |
| Efficiency (%) | | | |
| MFI fold change | 92.0 | 112.1 | 156.9 |

TABLE 2

| Squeezing length | 40 μm | 70 μm | 100 μm |
|---|---|---|---|
| Delivery | 99.92% | 99.87% | 98.83% |
| Efficiency (%) | | | |
| MFI fold change | 65.9 | 78.7 | 98.9 |

FIG. 13 shows the results of testing the intracellular delivery efficiency based on the type of material delivered.

In this experiment, two types of materials were used: a sample diluted to 0.3 mg/mL of 2,000 kDa FITC-conjugated dextran (Sigma Aldrich, FD2000S), and a sample of green fluorescent protein expressing mRNA (EGFP mRNA; TriLink, L-7601) diluted to 20 μg/mL. Cells treated with the intracellular delivery platform were cultured for 18 hours for FITC-Dextran delivery and 24 hours for EGFP mRNA delivery, then analyzed using a flow cytometer (Merck, Guava EasyCyte) to compare delivery efficiency with a control example. A microscope (Zeiss, Axio Observer 7) and camera (ZEISS, Axiocam 305 mono) were used to qualitatively compare the bright field and GFP images of the control and material delivery samples.

The control example used cells exposed to the same concentration of FITC-dextran or EGFP mRNA for the same duration as the embodiments but without using the intracellular delivery platform. Instead, these examples assessed the endocytosis effect.

In the control examples that did not use droplets and the intracellular delivery platform, there was almost no material delivery into the cells for both 2,000 kDa FITC-conjugated dextran and fluorescent protein-expressing mRNA. In contrast, the use of the intracellular delivery platform according to the invention resulted in high-efficiency material delivery into cells. The results confirmed that regardless of the type of material being delivered, the intracellular delivery platform of the invention showed high efficiency. The efficiency of intracellular delivery depending on the compressing block in these experiments is presented in Table 3 below.

TABLE 3

| | Comparative Example | |
|---|---|---|
| 2,000 kDa FITC-Dextran | 5.06% | 99.85% |
| Delivery efficiency (%) | | |
| EGFP mRNADelivery | 5.02% | 100.00% |
| efficiency (%) | | |

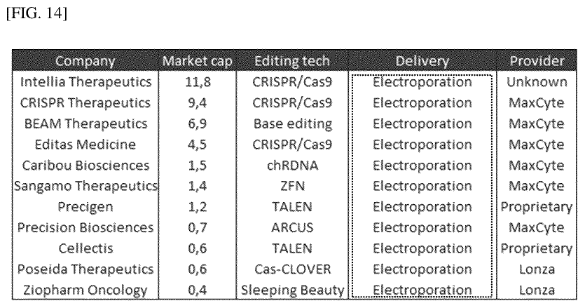

FIG. 14 illustrates the results of gene delivery in cells using conventional universal devices. FIG. 15 compares the efficiency of editing the EMX1 target gene using these conventional devices. FIG. 14 shows cell material delivery data published by MaxCyte (2021), and FIG. 15 examines the efficiency of editing the EMX1 target gene in K562 cells using the cell material delivery platform (droplet) of the present invention, compared to conventional electroporation (EP) devices and lipid nanoparticles (LNP).

In the experiment of FIG. 15, the method of experiment 11 was adopted. The cell suspension contained K562 cells' EMX1 expression gene targeting sgRNA (Single guide RNA) and endotoxin-free Cas9 protein, each added at 500 pmol. Cells treated through this cell material delivery platform were cultured for 48 hours, then genomic DNA (gDNA) was extracted using a DNA extraction kit (Intron biotechnology, G-spin Total DNA Extraction Mini Kit). The gDNA was amplified using PCR (Polymerase Chain Reaction) in a thermal cycler (Bio-Rad, T100). Quantified using a microvolume spectrophotometer (ThermoFisher, NanoDrop One), 200 ng of the PCR product was treated with 10 U of T7 Endonuclease 1 (New England BioLabs, M0302S) at 37° C. for 15 minutes, then gene editing efficiency was analyzed through electrophoresis (Bio-Rad, BR164-0302). K562 cells treated with lipid nanoparticles (Invitrogen; Lipofectamine 3000) and electroporation (ThemoFisher, Neon Transfection System) were analyzed in the same manner. This experiment was repeated three times, confirming significantly higher gene editing efficiency in cells treated with the droplet-based cell material delivery platform of the present invention compared to the conventional EP and LNP devices.

The cell material delivery platform (droplet) according to the present invention showed exceptionally high gene editing efficiency compared to electroporation (EP) and lipid nanoparticles (LNP). It was confirmed that multiplexing editing (editing of two or more targets) and high-efficiency editing are possible. Furthermore, the cell material delivery platform of this embodiment facilitated high-efficiency Homology Directed Repair (HDR) editing. In other words, the cell material delivery platform of the present invention can deliver materials into cells with high efficiency without damaging the cells and can be applied to various cells without restrictions.

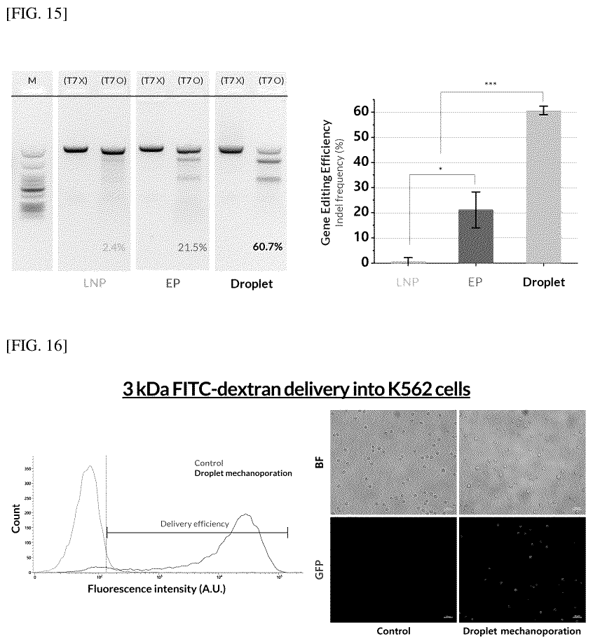

FIG. 16 shows the results of cell material delivery using a droplet-separation type cell material delivery platform. FIG. 16 used the droplet-separation type cell material delivery platform described in FIG. 7.

The manufacturing method for the droplet-separation type cell material delivery platform used in FIG. 16 was the same as that for the cell material delivery platform described in FIG. 11.

The cell material delivery platform in FIG. 16 features a straight channel length of 1.4 mm and an average inner width of 0.4 mm in the main channel where the droplets are formed at the inlet, followed by a curved channel length of 2.51 mm and an average inner width of 0.2 mm, and again a straight channel length of 1 mm and an average inner width of 0.2 mm. This is connected to a pair of branch sections with an average inner width of 0.09 mm. The height of the compressing block here is 8 μm, and the length is 70 μm.

The cell suspension used in this experiment included K562 cells (ATCC, CCL-243), and the transmission material used was 3 kDa FITC-conjugated dextran (Sigma Aldrich, FD4) diluted to a concentration of 0.3 mg/mL. After operating the cell material delivery platform, the cells trapped in the droplets were separated using a PFO solution (Sigma Aldrich, 1H,1H,2H,2H-Perfluoro-1-octanol) in a demulsification process. The survival rate of these cells was measured using an automatic cell counter (Logos biosystems, Luna-FX7), and a survival rate of around 80% was confirmed. The cells were then analyzed after 18 hours of culture using a flow cytometer (BD, FACSLyric). The results showed more than 90% delivery efficiency and more than a 100-fold change in mean fluorescence intensity compared to the control. Optical microscopy (Zeiss, Axio Observer 7) and a camera (ZEISS, Axiocam 305 mono) were used to qualitatively compare the bright field and GFP images of the control and material delivery samples. The results also confirmed that the cell material delivery platform according to this embodiment showed a higher material delivery efficiency.

A person skilled in the art of this field of the invention would understand that the invention can be implemented in other specific forms without altering its technical spirit or essential features. Therefore, the embodiments described above should be considered in all respects as illustrative and not restrictive. The scope of the invention is defined by the claims that follow, rather than the detailed description above, and all changes or modifications derived from the meaning and range of the claims and their equivalent concepts should be interpreted as being included within the scope of the invention.

What is claimed is:

1. An intracellular delivery platform comprising:
at least one main channel extending in a first direction from one end to another, equipped with a fluid passage internally;
a first supply part connected to one end of the main channel for injecting the first fluid containing the cells and material; and
a second supply part connected to one end of the main channel for injecting a second fluid that does not mix with the first fluid;
wherein the main channel internally includes one or more compressing blocks.

2. The intracellular delivery platform of claim 1, wherein the first fluid is an aqueous phase and the second fluid is an oil phase.

3. The intracellular delivery platform of claim 1, wherein the first supply part extends parallel to the first direction and is connected to one end of the main channel, and the second supply part is connected at an angle to the first supply part at one end of the main channel.

4. The intracellular delivery platform of claim 3, wherein the first fluid is delivered to one end of the main channel from the first supply part, and the second fluid is delivered to one end of the main channel from the second supply part at an angle to the flow direction of the first fluid, forming the first fluid containing the cells and material into droplets, and the droplets pass through the main channel within the second fluid.

5. The intracellular delivery platform of claim 3, wherein the second supply part includes first and second supply channels, and the first and second supply channels are connected to one end of the main channel to form a junction.

6. The intracellular delivery platform of claim 1, wherein the compressing block is provided at a distance of a first length from one end of the main channel, and the first length is 30% to 90% of the total length from one end to the other end of the main channel.

7. The intracellular delivery platform of claim 1, wherein the flow rate of the second fluid in the main channel is 1 mL/h to 70 mL/h.

8. The intracellular delivery platform of claim 1, further including one or more subchannels connected at an angle to the main channel, through which the second fluid flows.

9. The intracellular delivery platform of claim 8, wherein the subchannels comprising the first and second subchannels; and the first and second subchannels are connected to opposite sides of the main channel; wherein each of the first and the second subchannels being connected to the main channel at a distance of the second length away from one end of the main channel.

10. The intracellular delivery platform of claim 9, wherein the inner width of the subchannels is 20% to 150% of the first width, which is the inner width of the main channel, and the second fluid is delivered to the main channel through the subchannels.

11. The intracellular delivery platform of claim 10, wherein the inner width of the subchannels is 20 μm to 200 μm, and the first width, which is the inner width of the main channel, is 20 μm to 1.5 mm.

12. The intracellular delivery platform of claim 9, wherein the flow rate of the second fluid in the main channel is 1 mL/h to 45 mL/h, and the flow rate of the second fluid in the subchannels is 1 mL/h to 30 mL/h.

13. The intracellular delivery platform of claim 8, wherein the compressing block is provided at a distance of a first length from one end of the main channel, and the first length is 1.1 to 5 times the second length.

14. The intracellular delivery platform of claim 13, wherein the first width is 20 μm to 1.5 mm, the first length is 0.1 mm to 30 mm, and the second length is 0.1 mm to 1.5 mm.

15. The intracellular delivery platform of claim 1, wherein the length of the compressing block parallel to the first direction is 10 μm to 200 μm.

16. The intracellular delivery platform of claim 15, wherein the length of the compressing block parallel to the first direction is 20 μm to 100 μm.

17. The intracellular delivery platform of claim 1, wherein the gap between the compressing block and the inner surface of the main channel is provided as a second width, and the second width is 0.1% to 85% of the first width, which is the inner width of the main channel.

18. The intracellular delivery platform of claim 17, wherein the second width is 2 μm to 17 μm.

19. The intracellular delivery platform of claim 1, wherein the height of the compressing block perpendicular to the first direction is 15% to 99% of the first width.

20. The intracellular delivery platform of claim 19, wherein the height of the compressing block perpendicular to the first direction is 3 μm to 1.5 mm.

21. The intracellular delivery platform of claim 1, wherein the main channel includes:
an inlet section connected to the first supply part;
a branching section connected to the inlet section, but divided into multiple passages; and
an outlet section connected to the branching section; where the branching section includes multiple passages with smaller widths than the inlet and outlet sections and links where these passages branch or connect, and the compressing block is provided in the branching section or the outlet section.

22. The intracellular delivery platform of claim 21, wherein droplets formed of the cells, material, and the first fluid are transferred from the inlet section through the branching section to the outlet section via the second fluid, and the droplets provided in the inlet section have a larger average diameter than those in the branching or outlet sections.

23. The intracellular delivery platform of claim 21, wherein the branching section is symmetrically arranged around a virtual baseline that connects the inlet and outlet sections.

24. The intracellular delivery platform of claim 21, wherein the main channel further includes one or more curved passages provided in the inlet or branching section.

25. The intracellular delivery platform of claim 1, wherein the material includes one or more of nucleic acids, proteins, transcription factors, vectors, plasmids, gene editing materials, and nanoparticles.
